(19) United States
(12) Patent Application Publication
(10) Pub. No.: US 2016/0309675 A1
(43) Pub. Date: Oct. 27, 2016

(54) DISPOSABLE POLE TO ENCOURAGE LOCALIZED URINATION OF A PET

(71) Applicant: Eva Barys, Wilmette, IL (US)

(72) Inventor: Eva Barys, Wilmette, IL (US)

(21) Appl. No.: 15/137,598

(22) Filed: Apr. 25, 2016

Related U.S. Application Data
(60) Provisional application No. 62/178,981, filed on Apr. 25, 2015.

(51) Int. Cl. A01K 1/01; A01K 29/00

(52) U.S. Cl. CPC A01K 1/0107; A01K 29/00

(57) ABSTRACT

The invention relates to a disposable pole to encourage localized urination of a pet or dog. The present invention relates to a disposable pole that may be placed indoors on absorbent material to encourage a pet to urinate in a particular location, for ease in cleanup when a pet or dog urinates indoors.

### CROSS-REFERENCE TO RELATED APPLICATION

This application claims the benefit of U.S. Provisional Application No. 62/178,981, filed Apr. 25, 2015.

### FIELD OF THE INVENTION

The invention relates to a disposable pole to encourage localized urination of a pet. More particularly, the present invention relates to a disposable pole that can be placed indoors on absorbent material to encourage a pet to urinate in a particular location.

### BACKGROUND

Many pet or dog owners are conscious of how long their pet is left at home unattended, particularly conscious of the need for their pet to urinate. Many owners return home to a pet having urinated in locations that are not ideal for quick and thorough cleaning, for instance on carpets, rugs, furniture or houseplants. This creates difficulty for pet owners in many ways. Pet urination on such locations requires the purchase and use of specialized cleaning products, which may not be healthy in a home environment. The odor of dog urination in homes it also notable to dog owners and visitors. Pet and dog owners find themselves replacing carpets, rugs and furniture more frequently than those that do not own pets, creating an additional financial burden.

It is well known that when pet owners take their pets and dogs outside to relieve themselves, that there is a natural affinity to urinate on poles or pole-like fixtures such as fire hydrants, trees, lampposts and the like.

Attempts have been made to encourage localized urination by installing a plastic pee post in the yard. The plastic pee post is also intended for training of a pet, and for outdoor use. Such a pee post is made of plastic, which raises concerns for the environment.

### SUMMARY OF THE INVENTION

The present invention encourages localized urination of a pet. More particularly, the present invention is a disposable pole that may be placed indoors to elicit the natural tendencies of pets and dogs to urinate of pole-like objects and fixtures.

The present invention is a disposable pole that may be configured from a flat material, that is rolled into a pole configuration with tabs on the inferior end to create stability to stand the pole upright. The disposable pole may be placed indoors or outdoors. Preferably, the disposable pole is placed indoors to encourage urination on the pole, and deter urination in undesirable locations in a home, such as on carpets, rugs, furniture or houseplants.

The disposable pole of the present invention may be constructed of recycled, degradable or biodegradable material to ease the negative impact on the environment and avoid the use of plastics.

The disposable pole of the present invention may be placed on a variety of absorbent material to facilitate easy cleanup by a user, after a pet has urinated on the pole. The absorbent material may be disposable or non-disposable. After a pet has urinated near the disposable pole, preferably on the absorbent material, the caretaker of the pet may easily collect and dispose the pole and disposable absorbent material, or clean the non-disposable absorbent material.

The disposable pole of the present invention may optionally be treated with pheromones, to attract pets and dogs to localize urination on the pole.

### BRIEF DESCRIPTION OF THE DRAWINGS

FIG. 1 illustrates a view of the disposable pole as configured for use in an upright position.

FIG. 2 illustrates a view of the outer surface of the disposable pole prior to configuring for use.

FIG. 3 illustrates a view of the inner surface of the disposable pole prior to configuring for use.

### DETAILED DESCRIPTION OF THE INVENTION

While the present disclosure may be susceptible to embodiments in different forms, the drawings show, and herein will be described in detail, embodiments with the understanding that the present description is to be considered an exemplification of the principles of the disclosure and is not intended to be exhaustive or to limit the disclosure to the details of construction and the arrangements of the components set forth in the following description or illustrated in the drawings.

The present invention provides a disposable pole to encourage localized urination of a pet or dog. Particularly, dogs have a natural tendency to urinate on pole-like fixtures. It is to this end that the present invention is preferably utilized indoors when a caretaker of the pet is unavailable to take the pet outside to urinate, or weather may not permit taking a pet outside. The disposable pole of the present invention is easy to configure, usually in under 30 seconds for an average user, and installation takes only several seconds. The present invention makes it easy clean up after a pet urinates is more eco-friendly than using plastic poles on the market, and may speed up the housebreaking process of a pet.

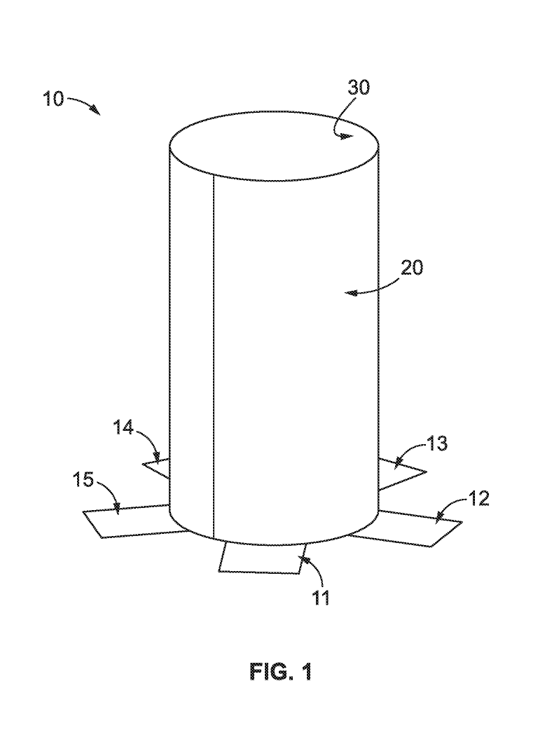

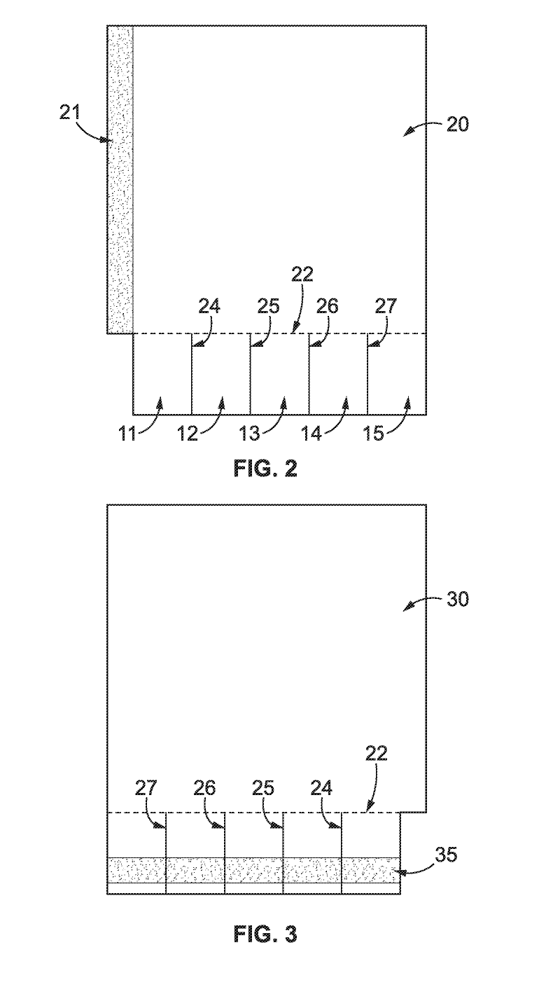

The disposable pole, indicated in FIG. 1, of the present invention is configured from flat material, as shown in FIG. 2 and FIG. 3. The outer surface of the disposable pole is illustrated in FIG. 2 and the inner surface of the disposable pole is illustrated in FIG. 3.

The disposable pole may be constructed to be more eco-friendly than the prior art and avoids plastic in its construction. The disposable pole of the present invention may be constructed of recycled, degradable or biodegradable material to ease the negative impact of consumption on the environment. In an embodiment, the disposable pole is constructed from a paper product selected from, but not limited to, paper, copy paper, poster board, light cardboard, card stock, construction paper, coated paper, bond paper, cotton paper, inkjet paper, wallpaper, woven paper, cardboard and the like. The material may have a minimum thickness of about 0.004 inches.

FIG. 1, illustrates the disposable pole 10 having a cylindrical pole-like shape, configured to be stabilized by stabilizing tabs 11, 12, 13.

In FIG. 2 illustrates the pre-configured flat form of the material prior to being configured into the disposable pole 10. FIG. 2 depicts the outer surface 20 of the disposable pole comprises an adhesive 21. The adhesive 21 may be any form of tape or glue, which may be applied immediately before use, or may be pre-secured on initial manufacture. In an embodiment, the adhesive 21 may be double-sided tape secured to an edge of the outer surface 20.

Stabilizing tabs 11, 12, 13, 14, 15, are folded towards the outer surface 20, along a fold line 22 and are separated by slits 24, 25, 26, 27. In an embodiment, a minimum of two stabilizing tabs 11, 12, 13, 14 15 are present to stabilize the disposable pole 10 when configured to stand upright.

FIG. 3 illustrates the inner surface 30 of disposable pole 10, as flat and prior to configuration. An adhesive 35 is secured to the back of the stabilizing tabs 11, 12, 13, 14, 15. The adhesive 35 may be any form of tape or glue, which may be applied immediately before use, or may be pre-secured on initial manufacture. In an embodiment, the adhesive 35 may be double-sided tape secured to each stabilizing tab. The double-sided tape may be severed along the slits, 24, 25, 26, 27.

To configure the disposable pole 10, the covering double-sided tape, adhesive 35 and adhesive 21 are removed. The stabilizing tabs are folded, along fold line 22 towards the outer surface 20. The flat configuration is rolled into a cylindrical pole-like shape, to lengthwise meet adhesive 21 of the outer surface 20 to the edge of the inner surface 30, to engage adhesive 21 to secure a pole shape. Stabilizing tabs are at the inferior end of the disposable pole, and are perpendicular to the configured pole, and adhesive 35 is engages and secures the disposable pole 10 to the surface on which the disposable pole will stand.

The disposable pole of the present invention may be placed on a floor indoors our on the ground in an outdoor location or in a garage. It may be secured directly onto a floor surface or may be placed on an absorbent material. Placing the disposable pole on an absorbent material may facilitate easy cleanup by a user after a pet has urinated on the pole. The absorbent material may be non-disposable material that may require washing, such as towels, washcloths, sponges, foam and the like. The disposable pole may be placed on disposable absorbent material to aid in easy cleanup. After a pet has urinated near the disposable pole, preferably on the absorbent material, the caretaker of the pet may easily collect and dispose the pole and disposable absorbent material. The disposable absorbent material may be selected from, but not limited to, a variety of materials such as, paper products, paper towels, toilet paper, newspaper, Zorb It-Up Amazing Absorbent Sheets, diapers, diaper pads, cotton, absorbent polymers, Abzorbeez, sponges or any other absorbent material.

The disposable pole of the present invention may also be treated with pheromones to attract and additional encourage localized urination from a dog. Any suitable pheromone off the shelf may be used and may be selected from, but not limited to, Four Paws Wee-Wee Puppy Housebreaking Aid, Nature's Miracle Housebreaking Go Here, dog appeasing pheromones, apasine, ADAPTIL and the like

The present invention may be of any size or any circumference. The size of the disposable pole may be smaller for small pets, or larger for larger pets. In an embodiment, the height of the disposable pole is 6 inches having a circumference of 6 inches. The height of the disable pole may be minimum of two inches, which may be used for small puppies. The shape of the disposable pole of the present invention is not limited to a cylindrical pole shape, for instance, the invention may be adapted to the shape of varying pole-like fixtures. Examples of shapes include, but are not limited to, cones, posts, fire hydrants, trees, trunks, poles, plants and the like.

The disposable pole of the present invention may be of any color and may have images or any kind, such as logos, messages, pictures, and the like on the whole disposable pole or any portion of the disposable pole. These may be applied by any means including, but not limited to, printed, imprinted, painted, embossed, colored, watermarked and the like. Images and colors may mimic typical pole-like fixtures that pets and dogs are accustom to urinating on, such as trees, fire hydrants, posts, cones, poles, plants, trunks and the like.

Although preferred embodiments of the disclosure are illustrated and described in connection with particular features, it will be apparent to those skilled in the art pet or dog care that the present invention, or variations thereof, can be adapted for use for a wide variety of housebreaking, pet care, pet training or localized urination measures. Various features of the disclosure have been particularly shown and described in connection with illustrated embodiments. However, it must be understood that the particular embodiments merely illustrate and that the invention is to be given its fullest interpretation within the terms of the claims.

1. A disposable pole to encourage localized urination of a pet comprising:
a. a paper product having minimum thickness of 0.004 inches;
b. said paper product is configured into a pole having an inner surface and an outer surface, wherein an adhesive secures the said inner surface to said outer surface to form a cylindrical shape;
c. said pole comprises at least two stabilizing tabs at the inferior end of the pole, wherein said stabilizing tabs are separated from each other by slits, and are folded along a fold line towards said outer surface of said pole; and
d. said stabilizing tabs comprise an adhesive to secure the stabilizing tabs to a surface on which said pole stands.

2. The disposable pole of claim 1, wherein said paper product is selected from paper, copy paper, poster board, light cardboard, card stock, construction paper, coated paper, bond paper, cotton paper, inkjet paper, wallpaper, woven paper and cardboard.

3. The disable pole of claim 1, wherein said paper product is biodegradable.

4. The disable pole of claim 1, wherein said paper product a recycled paper product.

5. The disposable pole of claim 1, wherein said disposable pole is treated with a pheromone to attracts dogs.

6. The disposable pole of claim 5, wherein said pheromones are selected from a group consisting of Four Paws Wee-Wee Puppy Housebreaking Aid, Nature's Miracle Housebreaking Go Here, dog appeasing pheromones, apasine and ADAPTIL.

7. A disposable pole to encourage localized urination of a pet comprising:
a. a paper product, wherein said paper product is configured into a pole having an inner surface and an outer surface, said outer surface comprising an adhesive to secure said inner surface to said outer surface to form said pole having a cylindrical shape;
b. said pole comprises at least two stabilizing tabs at the inferior end of the pole, wherein said stabilizing tabs are separated from each other by slits, and are folded along a fold line towards said outer surface of said pole; and
c. said stabilizing tabs comprise an adhesive to secure the stabilizing tabs to a surface on which said pole stands.

8. The disposable pole of claim 7, wherein said paper has a minimum thickness of 0.004 inches.

9. The disposable pole of claim 7, wherein said disposable pole further comprises pheromones to attract dogs.

10. The disposable pole of claim 9, wherein said pheromones are selected from a group consisting of Four Paws Wee-Wee Puppy Housebreaking Aid, Nature's Miracle Housebreaking Go Here, dog appeasing pheromones, apasine and ADAPTIL.
